(19) United States
(12) Patent Application Publication
(10) Pub. No.: US 2026/0022588 A1
(43) Pub. Date: Jan. 22, 2026

(54) AUTOMATED OPENING MODULE FOR A DOOR OF A HOUSEHOLD APPLIANCE

(71) Applicant: ILLINOIS TOOL WORKS INC., GLENVIEW, IL (US)

(72) Inventors: Bojan BICIC, Barasso (IT); Dino CHIRUMBOLO, Barasso (IT); Ahsan ALI, Barasso (IT); Joze LAVRENCIC, Barasso (IT)

(73) Assignee: ILLINOIS TOOL WORKS INC., GLENVIEW, IL (US)

(21) Appl. No.: 19/110,653

(22) PCT Filed: Sep. 19, 2023
(86) PCT No.: PCT/US2023/033136

§ 371 Date: Mar. 11, 2025

(30) Foreign Application Priority Data
Sep. 19, 2022 (EP) 22196421.6
May 11, 2023 (EP) 23172899.9
Sep. 18, 2023 (EP) 23198038.4

(51) Int. Cl. E05B 47/00

(52) U.S. Cl. CPC E05B 47/0012; E05B 2047/0017; E05B 2047/002; E05B 2047/0025; E05B 2047/0026

(57) ABSTRACT

An automatic opening module for a door of a household appliance includes a housing, a transmission system, and a lever engaging pin. The transmission system and the lever engaging pin are received within the housing. A first part of the transmission system is operably coupled to the lever engaging pin and a second part of the transmission system is configured to operably engage with an actuator of a door locking module such that actuation of the actuator causes the transmission system to move the lever engaging pin between a first, locked, position and a second, unlocked, position.

The invention relates generally to an automatic opening module. In particular, the invention relates to an automatic opening module for a door of a household appliance such as a washing machine or a dryer.

### BACKGROUND

Door-locking modules are typically used in household appliances such as washing machines and dryers to lock the door of the appliance. For example, washing machines and/or dryers typically use a door-locking module to securely lock the door of the appliance before starting a washing or drying cycle. Further, such door-locking modules are known to prevent the door from being opened during the washing or drying cycle, as well as prevent the washing or drying cycle from being started when the door of the appliance is open.

Existing door-locking modules contain a multitude of mechanical components which cooperate with one another to mechanically lock and unlock the door of the household appliance. Usually, an actuator is connected to a control unit of the appliance to command the movement of a locking pin between a disengaged position, in which the locking pin does not engage with the appliance door, i.e. the door is open or openable, and a locked door position, in which the locking pin engages with the appliance door, i.e. the door is locked. Other door-locking modules may have a lock switch that cooperates directly with the locking pin in order to signal to a control unit of the appliance whether the locking pin is in a locked position or an unlocked position. However, door-locking modules that can determine the position of the locking pin often have a large number of components, thus, resulting in an assembly that occupies a large space. Also, such modules may only be compatible with a select range of appliances and modifications are often required to the door-locking modules in order to operably fit with different household appliances. For example, it is often necessary to rearrange the layout of conductive strips and parts within the casing of the module depending on the layout of a particular household appliance for it to work with that appliance. Accordingly, different models of the door-locking module have to be manufactured and assembled, requiring varying production equipment and production lines.

Automatic unlocking means or mechanisms may be provided within door-locking modules in order to implement automation of opening the door of the household appliance in ‘smart’ appliances. Such mechanisms include additional components, including an additional actuator, which increases the space required by the door locking module and further limits the range of appliances with which the door-locking module is compatible.

Therefore, it would be desirable to provide an improved door-locking module configured to mitigate the problems associated with the prior art. In particular, it is an object of the present invention to provide a door-locking module adapted to determine the movement and position of a locking pin, which is more compact (compared to other door locking modules) and that has an improved compatibility with different layouts and types of household appliances. It is a further object of the present invention to provide an automatic opening module that is configured to cooperate with door locking modules and thus has improved compatibility with different layouts and types of household appliances.

The present invention provides at least an alternative embodiment to automatic unlocking or opening means and mechanisms of the prior art.

### SUMMARY OF THE INVENTION

In accordance with the present invention there is provided an automatic opening module according to the appended claims.

According to an aspect of the present invention there is provided an automatic opening module for a door of a household appliance. The automatic opening module may comprise a housing, a transmission system and a lever engaging pin.

Said transmission system, for example, at least a part of said transmission system, may be received within said housing.

Said lever engaging pin, for example at least a part of said lever engaging pin, may be received within said housing.

A first part of said transmission system may be operably coupled to said lever engaging pin.

A second part of said transmission system may be configured to operably engage with an actuator of a door locking module. Actuation of the actuator may cause the transmission system to move the lever engaging pin between a first, locked, position and a second, unlocked, position.

According to another aspect of the present invention there is provided an automatic opening module for a door of a household appliance, comprising: a housing; a transmission system; and a lever engaging pin; wherein said transmission system and said lever engaging pin are received within said housing; wherein a first part of said transmission system is operably coupled to said lever engaging pin; and wherein a second part of said transmission system is configured to operably engage with an actuator of a door locking module such that actuation of the actuator causes the transmission system to move the lever engaging pin between a first, locked, position and a second, unlocked position.

The automatic opening module is thus configured to cooperate with door locking modules. The operable engagement of the second part of the transmission system with an actuator of a door locking module removes the requirement to provide an additional or more complex actuator to actuate the lever engaging pin of the automatic opening module. Furthermore, the receipt of the transmission system and the lever engaging pin within the housing enables the provision of an automatic opening module, which may be retrofitted with a door locking module to implement automation of opening the door of the household appliance and thus the provision of a ‘smart’ household appliance.

Advantageously, when in said first, locked, position, said lever engaging pin is moved into said housing of said automatic opening module, and when in said second, locked, position, at least part of said lever engaging pin is moved out of said housing of said automatic opening module.

Advantageously, the transmission system may be a gear assembly, for example a gear assembly comprising a plurality of gears.

Advantageously, the first part of said transmission system may comprise a first gear of said plurality of gears and said second part of said transmission system may comprises a second gear of said plurality of gears.

The gear assembly advantageously provides a compact arrangement that is particularly suitable for an automatic opening module that is configured to be used with other components of a door locking system for a household appliance, for example a door locking module. In other words, the gear assembly allows motion to be transferred over a predetermined spacing between the components, e.g., an actuator of a door locking module and the lever engaging pin.

Advantageously, the lever engaging pin may comprises a rack gear portion. The rack gear portion may be operably coupled to said first part of said transmission system. Said first gear of said plurality of gears may be a pinion gear. Said rack gear portion of said lever engaging pin and said first gear or said pinion gear of said plurality of gears may therefore form a rack and pinion gear pair.

Said rack gear portion advantageously enables the conversion of rotary movement of said transmission system to linear movement of the lever engaging pin within a predetermined spacing in between two components, e.g., an actuator of a door locking module and the lever engaging pin.

Advantageously, the first part of said transmission system may comprise a clutch mechanism.

Advantageously, said clutch mechanism may comprise a clutch ring comprising at least two resilient tooth members.

Advantageously, said clutch mechanism may comprise a plurality of apertures arranged on an inner surface of said first part of said transmission system.

The clutch mechanism advantageously ensures that the lever engaging pin is retained in the correct position, and can be reset to the correct position, between usage cycles without damage being caused to the transmission system. Advantageously, the clutch mechanism also compensates for variation or tolerances in the arrangement of components within the automatic opening module during assembly.

Advantageously, said automatic opening module may comprise a reset lever.

Advantageously, said reset lever may be slidingly engaged with said lever engaging pin.

Advantageously, said reset lever may comprise a body and a resilient arm. An opening may be defined between said body and said resilient arm.

Advantageously, said housing may comprise a protrusion extending from an inner wall of said housing.

Advantageously, said opening of said reset lever may be configured to receive said protrusion of said housing.

Advantageously, the reset lever enables the manual resetting of the automatic opening module without causing damage to the gears of the transmission system, for example in the event of an emergency.

Advantageously, said housing may comprise a first opening through which at least a portion of the second gear extends to operably engage with an actuator of a door locking module.

Advantageously, said housing may comprises a second opening through which at least a portion of the lever engaging pin extends.

### BRIEF DESCRIPTION OF THE DRAWINGS

Embodiments of the invention are now described, by way of example only, hereinafter with reference to the accompanying drawings, in which:

FIG. 1 illustrates a side view of a door-locking module, with the housing removed;

FIG. 2 illustrates a schematic representation showing a top view of an example embodiment of the door-locking module, (a) with the PCB attached, and (b) with the PCB removed;

FIG. 3 illustrates a close-up detailed perspective view of the locking pin end of the alternative door-locking module, (a) with the locking pin in a first position (i.e., towards unlocked), and (b) with the locking pin in a second position (i.e., locked position);

FIG. 4 shows a close-up of the cam-guide of the locking pin with a first and second ramp surface;

FIG. 5 illustrates a close-up side view of the locking pin end of the door locking module, (a) with the movable contact blade (actuator switch) in contact with a respective PCB circuit (indication a locked state), and (b) with the movable contact blade (actuator switch) moved out of contact with the respective PCB circuit (indication an unlocked state);

FIG. 6 illustrates (a) a partial top view of the manual actuator and actuator arm in a disengaged position, and (b) an exploded view of the gear and locking ring coupling including a clutch mechanism;

FIG. 7 illustrates a schematic representation showing a partial top view of the example of the door locking module (a) with the actuator arm of the manual actuator disengaged from the locking ring lever, and (b) with the actuator arm pushed down and the locking ring rotates and locking pin moves back into its unlocked position;

FIG. 8 illustrates a door locking system including a door-locking module and an automatic opening module according to an embodiment of the invention;

FIG. 9 illustrates the door locking system of FIG. 8 with an upper part of the housing removed;

FIG. 10 illustrates a top perspective view of an automatic opening module according to an embodiment of the invention;

FIG. 11 illustrates a bottom perspective view of the automatic opening module of FIG. 10;

FIG. 12 illustrates a top plan view of the automatic opening module of FIG. 10 with the upper housing part removed;

FIG. 13 illustrates an exploded view of the automatic opening module of FIG. 10;

FIG. 14 illustrates an exploded perspective view of the clutch mechanism and lever pin from the top, and

FIG. 15 illustrates the exploded view of the clutch mechanism and lever pin from the bottom.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g., central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

Like reference numerals are used to depict like features throughout, i.e., identical reference numerals are used for components identical in different examples or in different embodiments of the present invention.

Through the description and claims of this specification, the terms ‘comprise’ and ‘contain’, and variations thereof, are interpreted to mean ‘including but not limited to’, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality, as well as, singularity, unless the context requires otherwise.

### (a) Door-Locking Module

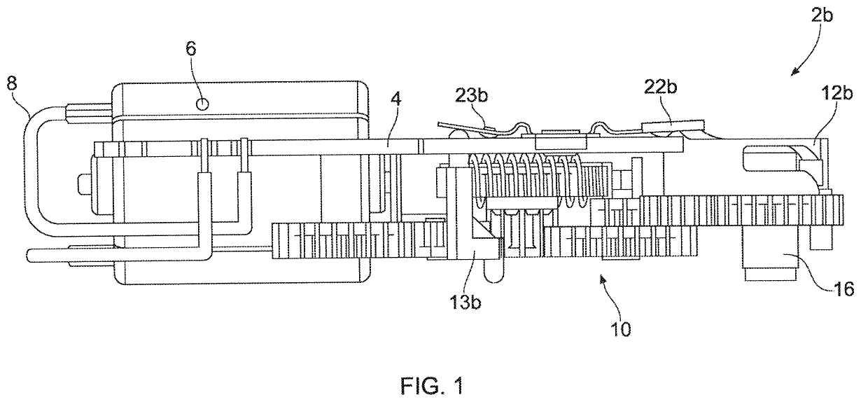

Referring now to FIG. 1, an example embodiment of a door-locking module 2b is illustrated including a PCB-top-mounted first and second actuators 22b, 23b and a respective locking ring 12b, as well as a door sensing pin 13b. The module 2b further includes a PCB 4, an electric motor 6 that is operably connected to the PCB 4 by electric wires 8, and a gear mechanism 10. The electric motor 6 may be a 12V DC motor having an output shaft connected to an extending worm gear shaft 11 that is operably coupled to the locking ring 12b (e.g., a cam member) via the gear mechanism 10. The gear mechanism 10 comprises at least three interconnected gears 10a, 10b and 10c. Functionally, the worm gear shaft 11 drives gear 10a coupled with gear 10b, which then drives gear 10c. The gear ratios between the respective engaging gears 10a, 10b, 10c and the worm gear 11 are chosen so that a given motor rotation provides a suitable rotational movement of the locking ring 12b. The locking ring 12b includes a cam guide 14 that is provided within a cylindrical wall portion of the locking ring 12b, as well as a trigger member 20b adapted to engage with the respective first actuator or sensor 22b. In the example embodiment of the door locking module 2b, the trigger member 20b comprises a cam surface provided on top of the cylindrical wall of the locking ring 12b.

The door-locking module 2b further includes a locking pin 16 adapted to engage with the cam guide 14 via a cam follower 18. The locking ring 12b is operably coupled to and coaxially arranged with the gear 10c, so as to directly transfer rotational movement of the gear 10c into rotational movement of the locking ring 12b. The rotational movement of the locking ring 12b and cam guide 14 then translates into a linear movement of the cam follower 18 and locking pin 16 (axial movement). In this particular example, the cam guide 14 is formed by an enclosed aperture within a portion of the cylindrical wall of the locking ring 12b, extending between a first aperture end and a second aperture end, thus, limiting the rotational movement of the locking ring 12b and the axial movement of the cam follower 18 to a predetermined range.

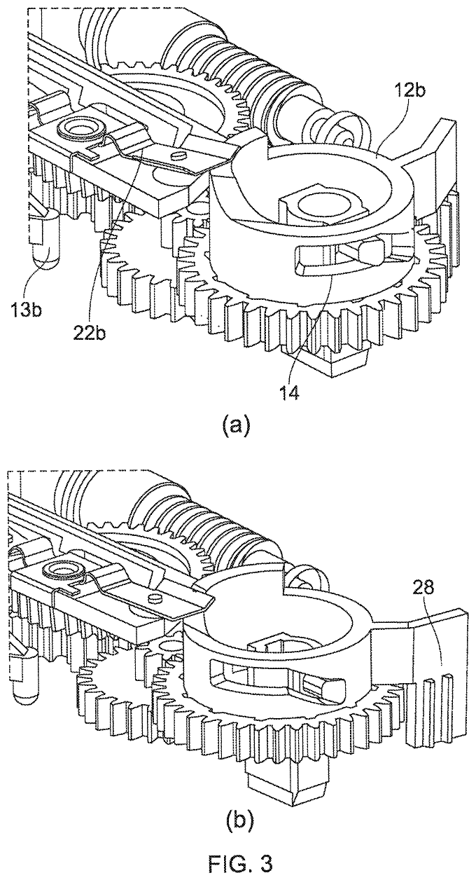

In a preferred example embodiment, the cam guide 14 may be formed by an aperture defining a first ramp at a first angle (with respect to the rotational or centre axis of the locking ring 12b) followed by a second ramp at a second angle (different from the first angle). For example, the lower portion of the aperture may be at a steeper angle than the following upper portion of the aperture (see, for example, FIG. 3, 4 or 5).

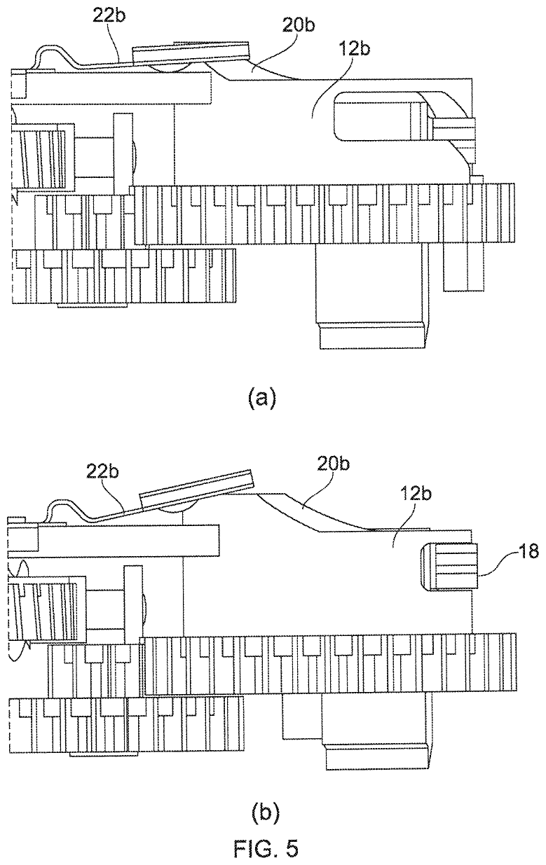

Referring now particularly to the example embodiment shown in FIG. 5, the first actuator or sensor 22b, provided on the printed circuit board 4 (PCB) for cooperation with the trigger member 20b, may be a movable contact blade. The second actuator or sensor 23b also be a movable contact blade. During use, the rotation of the locking ring 12b moves the trigger member 20b into or out of engagement with the first actuator 22b at a predetermined rotational position. For the example embodiment, a movable contact blade 22b (e.g., a resilient metal blade, see FIG. 5) is adapted to slidingly engage with the cam surface on top of the locking ring 12b (i.e., the trigger member 20b). During use, the cam surface on top of the locking ring 12b moves the resilient metal contact between a close-circuit position (FIG. 5(a)) and an open-circuit position (FIG. 5(b)) on the PCB 4. Further, the resilient metal contact (movable contact blade 22b) is biased towards the close-circuit position.

Referring back to FIG. 1, a door sensing pin 13b is provided between the second actuator or sensor 23b and the appliance door (e.g., via a linkage or other components engageable by the appliance door). Here, the door sensing pin 13b is arranged, so as to allow sliding movement between an engaged position, engaging the second actuator or sensor 23b (i.e., the bottom-mounted tactile switch, or the top-mounted movable blade contact), and a disengaged position, disengaged from the second actuator or sensor 23b. For example, when using the movable blade contact 23b, the door sensing pin 13b is configured, so as to slidingly move the resilient metal contact (i.e., spring contact) from the close-circuit position into the open-circuit position and vice versa. Further, it is understood by the person skilled in the art, that any other suitable door sensing mechanisms may be used. For example, a rotatable lever arm may be provided between the second actuator or sensor (e.g., a lever switch, or an optical switch) and the appliance door that is configured to move into and out of engagement with the second actuator or sensor in accordance with the position of the appliance door (i.e. closed or open).

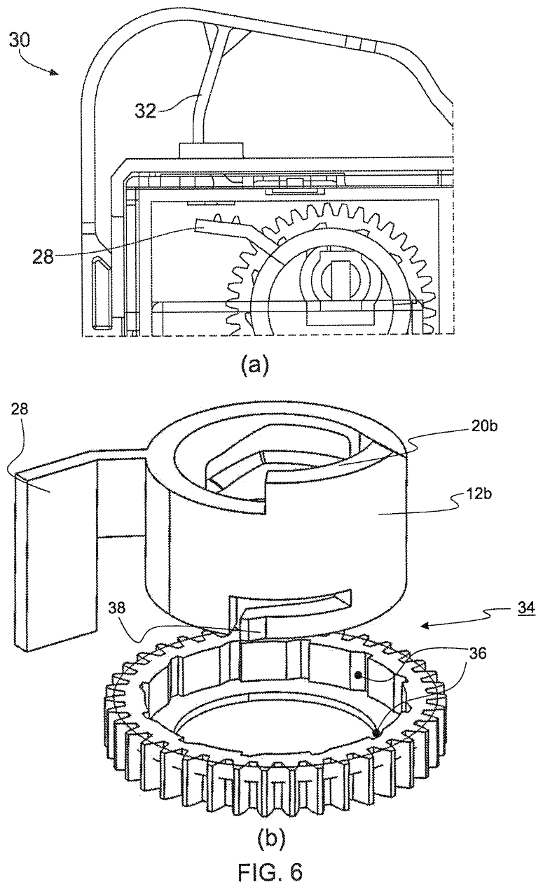

As illustrated particularly in FIG. 6, in the event that the appliance door has to be unlocked manually, a manual actuator 30 is provided to rotate the locking ring 12b back to its unlocked position (e.g., counterclockwise) via a locking ring lever 28. In order to prevent any damage to the gears 10a, 10b, 10c, 11 when manually rotating the locking ring 12b back to its unlocked position, a unidirectional clutch mechanism 34 is provided with the coupling between the gear 10c and the coaxially arranged locking ring 12b. The clutch mechanism 34 comprises a plurality of apertures or cavities 36 that are circumferentially equidistantly arranged on an inner surface of gear 10c (see FIG. 6(b)) and at least two resilient tooth members 38 provided within the cylindrical wall of the locking ring 12b. The resilient tooth members 38 are arranged so as to operably engage with the apertures or cavities 36, for example, the resilient tooth members 38 can slidably move from one aperture or cavity 36 to another in one direction (e.g. counter-clockwise), while the gears remain stationary, but lockingly engage with any one of the apertures or cavities 36 in the opposite direction (e.g. clockwise), thus rotating with the locking ring 12b.

The door locking module 2b is further provided with a housing 26 adapted to operably accommodate at least the component parts, such as, the PCB 4, motor 6 and wires 8, gear mechanism 10, locking ring 12b, door sensing pin 13b and locking pin 16.

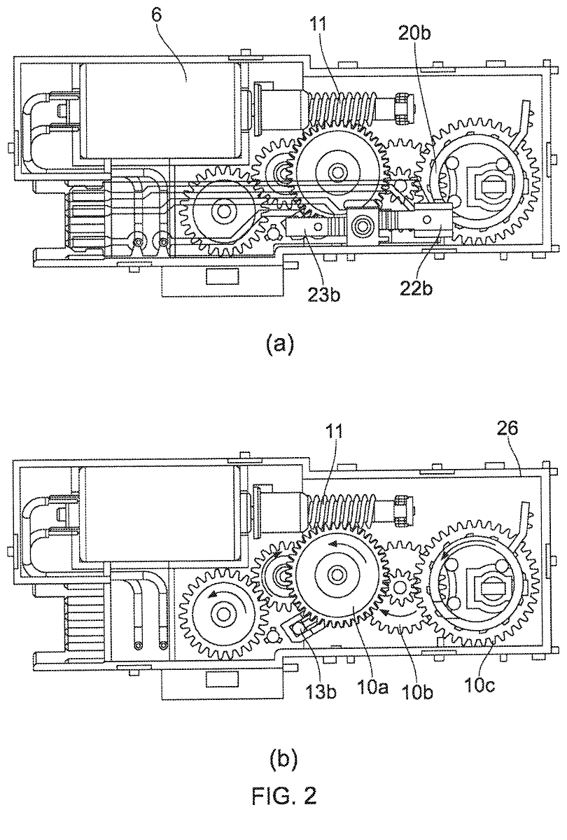

During operation and as illustrated in FIG. 2(b), the electric motor 6 is actuated or energised so that the output shaft of the electric motor 6 and the attached worm gear shaft 11 rotate in a desired direction. The worm gear shaft 11 engages gear 10a, which in turn engages gear 10b to then engage gear 10c and rotating the locking ring 12b. In FIG. 2(b) the directions of rotation are indicated by arrows on respective gears 10a, 10b, 10c. As such, the actuation of the electric motor 6 drives the locking ring 12b via gear mechanism 10 either clockwise or counterclockwise.

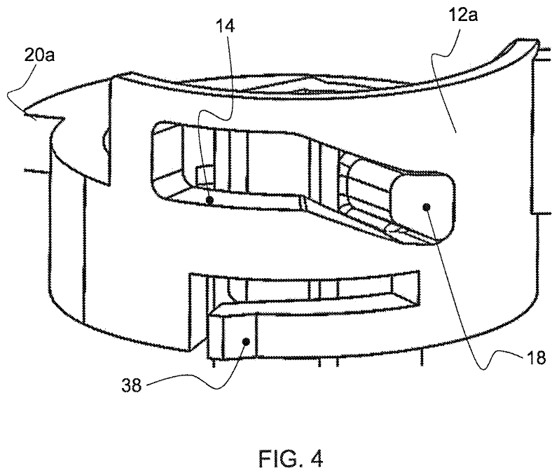

As shown in FIGS. 3 and 4, the rotational motion of the motor 6 is transferred onto the locking ring 12b via coupled gear 10c. Rotation of the locking ring 12b changes the position of the cam guide 14 relative to the engaged cam follower 18 of the locking pin 16, thus, axially moving the locking pin 16 between the locked and unlocked position. In particular, when the locking ring 12b is rotated counterclockwise, the cam follower 18 is positioned at a first end (left end or upper end) of the cam guide 14, causing the locking pin 16 to be moved up (unlocked from the appliance door). When the locking ring 12b is rotated clockwise, the cam follower 18 is positioned at the second end (right end or lower end) of the cam guide 14, causing the locking pin 16 to be moved down (locking the appliance door). Since the electric motor 6 is drivable bidirectionally (i.e., clockwise and counterclockwise), it is possible to control the position of the locking pin 16 via motor control.

Referring back to FIG. 5, the first actuator or sensor 22b is engaged by the trigger member 20b, which generates a signal corresponding to the position of the locking pin 16 indicating the locking state of the appliance door. For example, clockwise rotation of the locking ring 12b moves the trigger member 20b into switching engagement with the first actuator or sensor 22b causing a signal to be generated that indicates the locked position of the appliance door. Counterclockwise rotation of the locking ring 12b moves the trigger member 20b out of switching engagement with the first actuator or sensor 22b causing a signal to be generated that indicates the unlocked position of the appliance door. Further, integrating the actuator or sensor 22b with the PCB 4, so as to cooperate with the trigger member 20b allows the use of PCB's 4 with reduced dimensions (compared to present locking modules), because the position of the locking pin 16 is sensed directly from the position of the locking ring 12b.

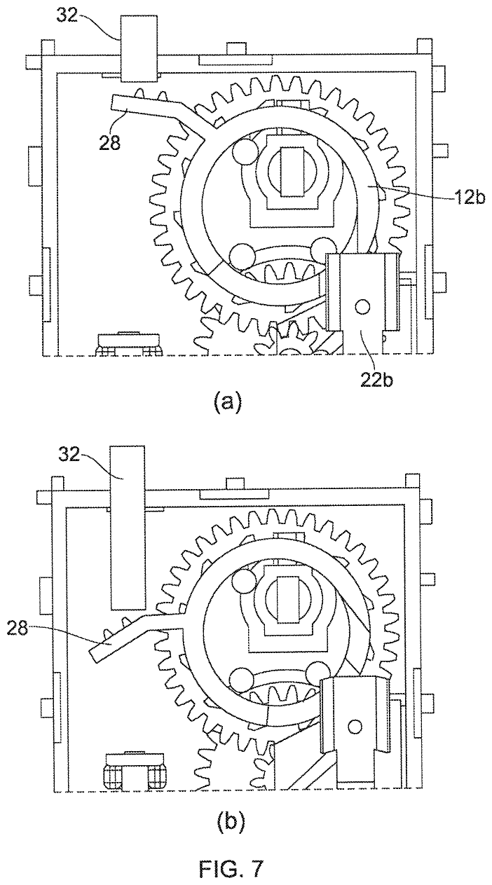

As illustrated in FIGS. 6 and 7, the clutch mechanism 34 is used to provide a manual unlock function of the appliance door that is decoupled from the gear mechanism 10. Here, the actuator arm 32 of the manual actuator 30 is pushed into engagement with the locking ring lever 28, thus, rotating the locking ring 12b counterclockwise relative to a stationary gear 10c, with the tooth member(s) 38 sliding through the apertures 36. This decoupled rotation of the locking ring 12b moves the locking pin 16 into the unlocked position.

### (b) Automatic Opening Module for a Door-Locking Module

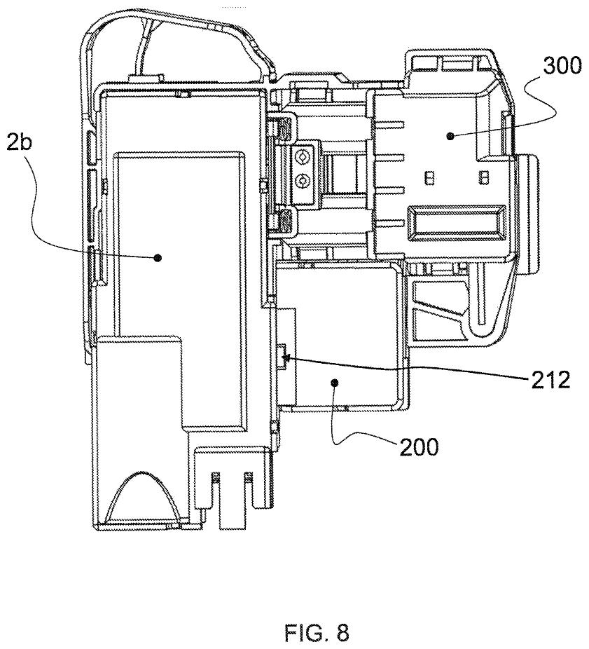

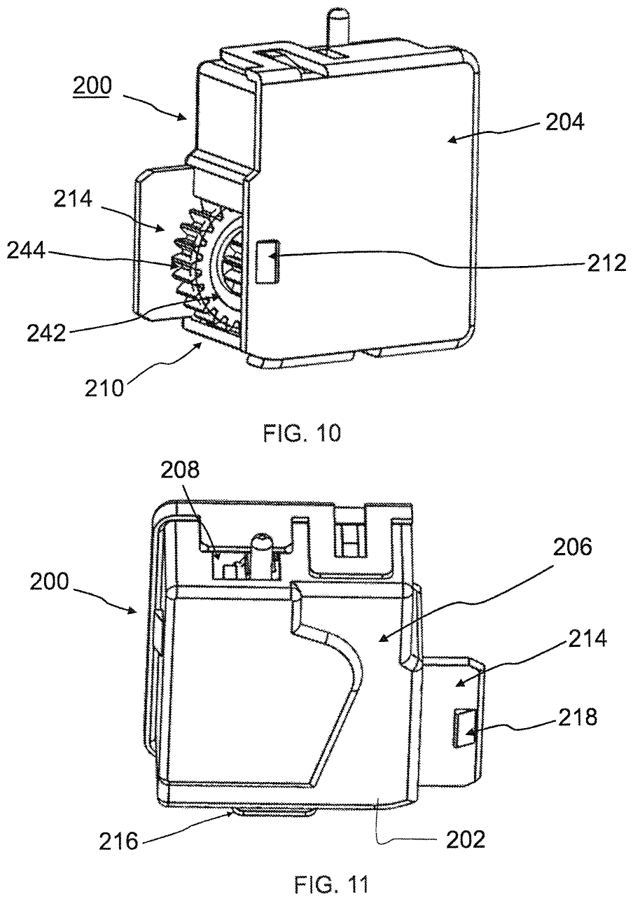

An automatic opening module 200 according to an example embodiment of the present invention will now be described with particular reference to FIGS. 8 to 15. The automatic opening module 200 is particularly suitable for use with a door-locking module 2b, as described in section (a), so as to form a door-locking system of a household appliance. However, it is understood by the person skilled in the art, that the automatic opening module 200 may also be used with any other suitable door-locking mechanisms or household appliances.

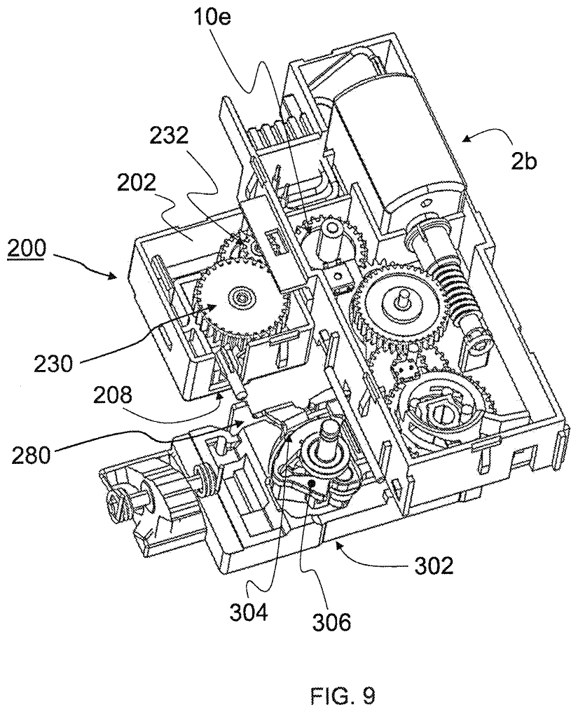

As illustrated in FIGS. 8 and 9, embodiments of the automatic opening module 200 may form part of a door locking system of a household appliance, the door locking system described includes a door locking module 2b (as described in section (a)) and an external module 300.

The automatic opening module 200 includes a housing 202. The housing 202 is generally cuboid, having four outer walls, a lower face or base and an upper face within which a hollow is defined. The housing 202 includes a top or upper housing cover 204 and a bottom or lower housing portion 206.

The upper housing cover 204 includes the upper face of the housing 202 and one or more walls which form part of one or more of the outer walls of the housing 202.

Similarly, the lower housing portion 206 includes the base of the housing 202 and one or more walls which form part of one of more of the outer walls of the housing 202.

The housing 202 also includes a first opening 208 and a second opening 210. Each of the first opening 208 and the second opening 210 are defined between the one or more walls of the upper housing cover 204 and the one or more walls of the lower housing portion 206.

A first catch portion 212 is provided on the upper housing cover 204 on the upper face of the housing 202.

The lower housing portion 206 includes a flange 214, which extends from one of the walls which form part of one of the outer walls of the housing 202, and a respective protrusions or teeth 216 adapted to lockingly engage with the upper housing cover 204. A second catch portion 218 is provided on an outer surface the flange 214 (i.e., the second catch portion 218 is provided on a surface of the flange which faces away from the hollow within the housing 202).

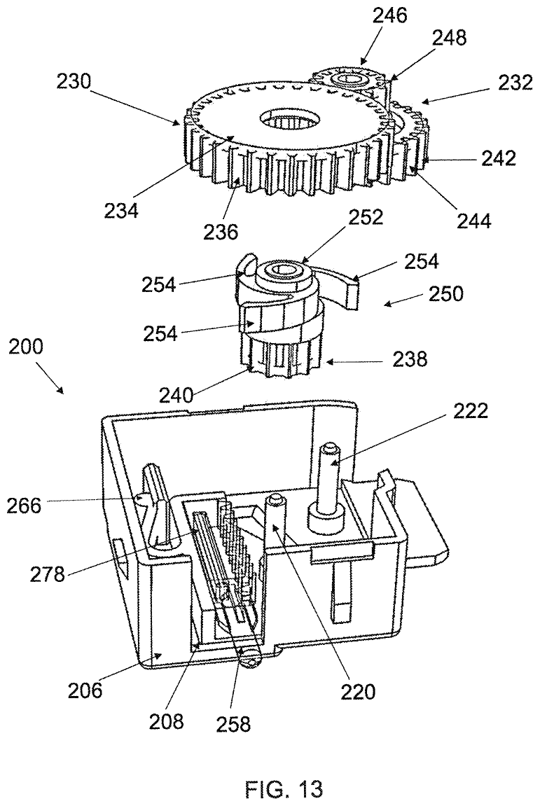

As shown in FIG. 13, a first shaft 220 and a second shaft 222 extend upwardly from the lower housing portion 206 (i.e., the first shaft 220 and the second shaft 222 extend from the base of the housing 202 into the hollow within the housing 202).

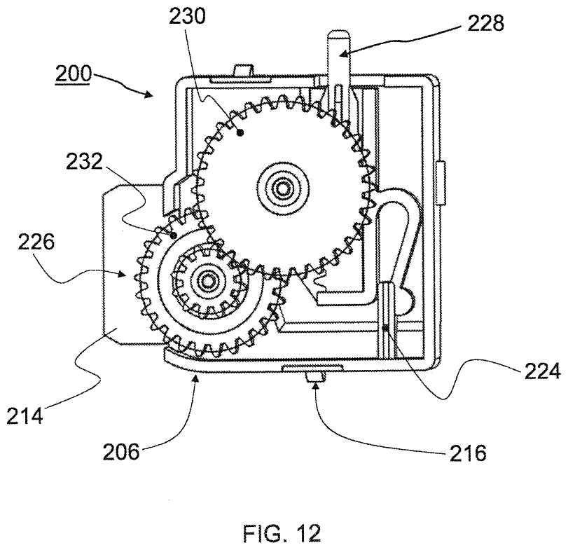

A rib 224 extends inwardly from one of the walls of the lower housing portion 206, as illustrated in FIG. 12.

The automatic opening module 200 also includes a transmission mechanism 226 and a lever engaging pin 228. The transmission mechanism 226 includes a first part, which is operably coupled to the lever engaging pin 228, and a second part, which is configured to operably engage with an actuator of a door locking module, for example, the gear member 10e (of gear assembly 10) and the electric motor 6 of the door locking module 2b.

With particular reference to FIGS. 12 and 13, the transmission mechanism 226 is a gear assembly including a plurality of gears. The first part of the transmission mechanism 226 includes a first gear 230 and the second part of the transmission mechanism 226 includes a second gear 232.

The first gear 230 includes a first gear member 234 having a plurality of outer teeth 236 and the second gear member 238 having a plurality of outer teeth 240. The second gear member 238 is operably coupled to and coaxially arranged with the first gear member 234 such that the second gear member 238 and the first gear member 234 rotate together. The diameter of the first gear member 234 is greater than the diameter of the second gear member 238.

Similarly, the second gear 232 includes a first gear member 242 having a plurality of outer teeth 244 and a second gear member 246 having a plurality of outer teeth 248. The second gear member 246 is coaxial with the first gear member 242, and the first and second gear members 242, 246 are integral parts. The diameter of the first gear member 242 is greater than the diameter of the second gear member 246. The gear ratios between the respective engaging gears 230, 232 are chosen so that a given motor rotation provides a suitable linear movement of the lever engaging pin 228 (described in more detail below).

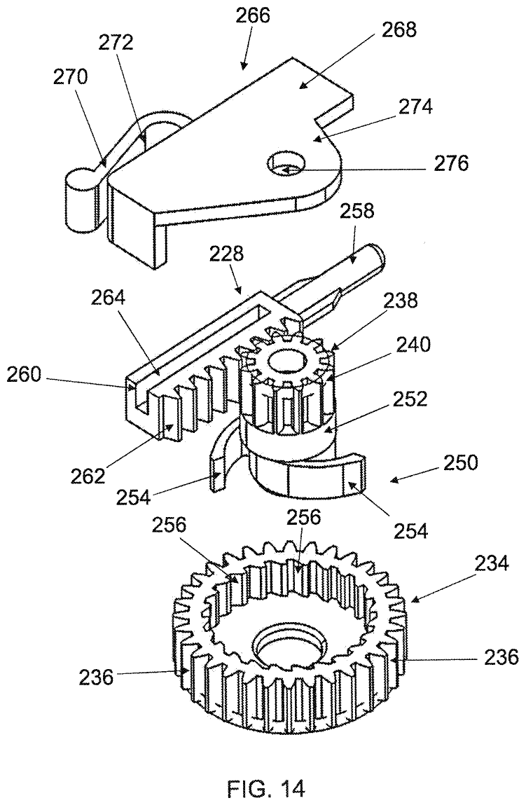

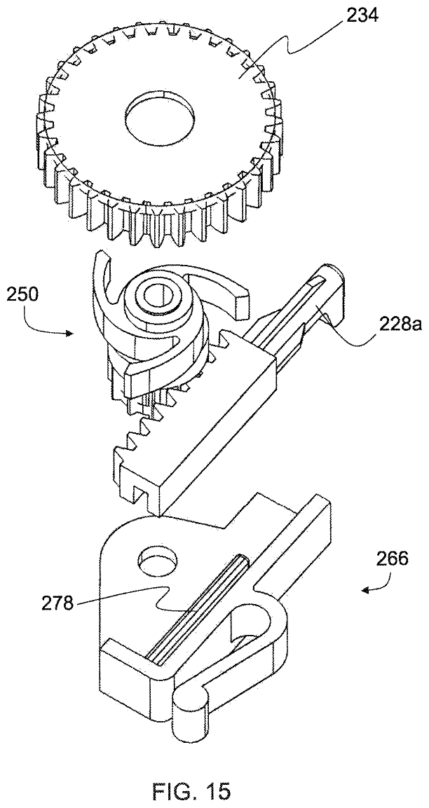

Furthermore, and as shown in detail in FIGS. 14 and 15, the first gear 230 incorporates a clutch mechanism 250 operably coupling the first and second gear member 234, 238 of the first gear 230. The clutch mechanism 250 includes a clutch ring 252, having two or more resilient tooth members 254 extending radially outward, and a plurality of apertures or cavities 256 that are circumferentially equidistantly arranged on an inner surface of the first gear member 234. The resilient tooth members 254 are arranged so as to operably engage with the apertures or cavities 256, i.e. the resilient tooth members 254 can slidably move from one aperture or cavity 256 to another in one direction (e.g. —clockwise) while the first and second gears 230, 232 remain stationary, but lockingly engage with any one of the apertures or cavities 256 in the opposite direction (e.g. counter-clockwise), thus rotating with the clutch ring 252.

The lever engaging pin 228 is an elongate body that has a pin portion 258 at a distal end and a rack gear portion 260 at a proximal end (inside the housing). The rack gear portion 260 includes a plurality of teeth 262, which extend along one edge of the rack gear portion 260, and a slot 264, which extends along one surface of the rack gear portion 260 (open towards the proximal end).

The automatic opening module 200 also includes a reset lever 266 (see also FIGS. 14 and 15). The reset lever 266 has a body 268 and a resilient arm 270. An opening 272 is defined between the body 268 and the resilient arm 270 of the reset lever 266. The body 268 includes a flange 274 through which an aperture 276 extends, and an elongate slider 278 which extends along the length of the body 268.

When assembled, the reset lever 266 is positioned within the lower housing portion 206, such that the protrusion 224 of the lower housing portion 206 is held within the opening 272 between the body 268 and the resilient arm 270 of the reset lever 266 and the first shaft 220 extends through the aperture 276 of the body 268 of the reset lever 266.

The lever engaging pin 228 is slidingly coupled with the reset lever 266 via the elongate slider 278 and the slot 264.

The first gear 230 is operably mounted onto the first shaft 220 such that the outer teeth 240 of the second gear member 238 of the first gear 230 engage the teeth 262 of the rack gear portion 260 of the lever engaging pin 228. The second gear 232 is operably mounted onto the second shaft 222 such that the outer teeth 248 of the second gear member 246 of the second gear 232 engage the outer teeth 236 of the first gear member 234 of the first gear 230.

The upper housing cover 204 is positioned over the lower housing portion 206 to form the housing 202. The pin portion 258 of the lever engaging pin 228 extends through the first opening 208 that is formed between the upper housing cover 204 and the lower housing portion 206. The first gear member 242 of the second gear 232 extends through the second opening 210 that is formed between the upper housing cover 204 and the lower housing portion 206. The flange 214 of the lower housing portion 206 extends below the first gear member 242 of the second gear 232.

The outer teeth 244 of the first gear member 242 of the second gear 232 engage with or interconnect with the outer teeth of a further gear 10e in a connection portion of the housing of the door locking module 2b, thereby providing an operable engagement between the actuator of the door locking module 2b and the transmission system 226.

Once assembled, the automatic opening module 200 may be installed on a door locking system by connecting the automatic opening module 200 to a door locking module 2b of a door locking system.

The automatic opening module 200 may be positioned adjacent to and aligned with the door locking module 2b, such that the outer teeth 244 of the first gear member 242 of the second gear 232 engage with or interconnect with the outer teeth of the gear 10e forming part of the gear assembly 10 of the door locking module 2b, and the second catch portion 218 on the flange 214 of the lower housing portion 206 engages a catch receiver on the housing of the door locking module 2b. Similarly, the first catch portion 212 on the upper housing cover 204 of the housing 202 engages a catch receiver on a flange of the housing 26 of the door locking module 2b.

In its final configuration (i.e., assembly, see FIG. 8 or 9), the automatic opening module 200 is arranged between the door locking module 2b and an external module 300 adapted to lock and release a sliding block 302 (part of the external module). In particular, and as described earlier, the automatic opening module 200 is operably coupled with the door locking module 2b via one of the gears 10e of the gear mechanism 10, and is adapted to operably engage with an operating lever 280 of the sliding block 302. The assembly and function of the external module 300 and its sliding block 302 is described in detail in document EP3483331B1, which is incorporated herein by reference.

In summary, the automatic opening module 200 of the present invention replaces the electrically activated actuator (described in EP3483331B1), i.e. the pin portion 258 of the lever engaging pin 228 is adapted to push the operating lever 280, so as to disengage a locking protrusion 304 of a rocking block 306 provided in the sliding block 302, thus, enabling the rocking block 306 to rotate within its cavity. The exact mechanism and function of the external module 300 and the included sliding block 302, locking protrusion 304 and rocking block 306 is beyond the scope of the description for the present invention and will not be described in any more detail (which can be found in EP3483331B1).

Consequently, the automatic opening module 200 provides for a simplified door locking module with a reduced complexity, as well as, a reduced number of components (such as an electrically powered solenoid), thus, minimising the costs of manufacture, as well as, minimising the risk of potential faults and malfunctioning when losing power. It is understood by the person skilled in the art, that the automatic opening module 200 may be incorporated as a retrofit to existing door locking systems.

Also, and as already described in previous paragraphs, during operation and as illustrated in FIG. 2(b), the electric motor 6 is actuated or energised so that the output shaft of the electric motor 6 and the attached worm gear shaft 11 rotate in a desired direction. The worm gear 11 engages gear 10a, which in turn engages gear 10b to then engage gear 10c and rotating the locking ring 12b.

Rotation of the gear 10a in the counterclockwise direction, as illustrated in FIG. 2(b) results in the rotation of gear 10e in the connection portion of the housing of the door locking module 2b in the counterclockwise direction.

Rotation of gear 10e results in rotation of the second gear 232 and subsequently of the first gear 230.

Anti-clockwise rotation of the first gear 230 moves the lever engaging pin 228 outwardly (clock-wise rotation moves the pin inwardly) and through the first opening 208 into an engaging contact so as to push the operating lever 280 against the biased locking protrusion 304 (e.g. a roller, see EP3483331B1 for specific details) of the rocking block 306, which will then “unlock” the rocking block 306 (see above) and allow rotation with in its cavity.

A clockwise rotation of the first gear 230 retracts the pin 228 out of engagement with the operating lever 280, releasing the biased locking protrusion 304 (e.g., spring biased roller) and “locking” the rocking block 306 within its cavity (i.e., prevent rotation of the rocking block 306).

The clutch mechanism 250 ensures that the inward movement of the lever engaging pin 228 is limited such that the pin portion 258 is in the correct position for the next cycle.

The clutch mechanism 250 thus advantageously ensures that the lever engaging pin 228 is retained in the correct position, and can be reset to the correct position, between usage cycles without damage being caused to the transmission system 226. Advantageously, the clutch mechanism 250 also compensates for variation or tolerances in the arrangement of components within the automatic opening module 200 during assembly. Through the description and claims of this specification, the words ‘comprise’ and ‘contain’ and variations of them mean ‘including but not limited to’, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

### Reference Numbers:

| 2b | door locking module |
|---|---|
| 4 | printed circuit board |
| 6 | electric motor |
| 8 | electric wires |
| 10 | gear mechanism |
| 10a-c, e | gears |
| 11 | worm gear shaft |
| 12b | locking ring |
| 13b | door sensing pin |
| 14 | cam guide |
| 16 | locking pin |
| 18 | cam follower |
| 20b | trigger member |
| 22b | first actuator |
| 23b | second actuator |
| 26 | housing |
| 28 | locking ring lever |
| 30 | manual actuator |
| 32 | actuator arm |
| 34 | clutch mechanism |
| 36 | apertures or cavities |
| 38 | tooth member |
| 116 | locking pin |
| 138 | plunger |
| 140 | bearings |
| 142 | leaf spring |
| 200 | automatic opening module |
| 202 | housing |
| 204 | upper cover portion |
| 206 | lower housing portion |
| 208 | first opening |
| 210 | second opening |
| 212 | first catch portion |
| 214 | flange |
| 216 | teeth |
| 218 | second catch portion |
| 220 | first shaft |
| 224 | rib |
| 226 | Transmission mechanism |
| 228 | lever engaging pin |
| 230 | 1^{st} gear |
| 232 | 2^{nd} gear |
| 234 | 1^{st} gear member (of 1^{st} gear) |
| 236 | outer teeth (of 1^{st} gear member of 1^{st} gear) |
| 238 | 2^{nd} gear member (of 1^{st} gear) |
| 240 | outer teeth (of 2^{nd} gear member of 1^{st} gear) |
| 242 | 1^{st} gear member (of 2^{nd} gear) |
| 244 | outer teeth (of 1^{st} gear member of 2^{nd} gear) |
| 246 | 2^{nd} gear member (of 2^{nd} gear) |
| 248 | outer teeth (of 2^{nd} gear member of 2^{nd} gear) |
| 250 | clutch mechanism |
| 252 | clutch ring |
| 254 | resilient tooth member |
| 256 | apertures or cavities |
| 258 | pin portion (of lever engaging pin) |
| 260 | rack gear portion (of lever engaging pin) |
| 262 | teeth (of rack gear portion) |
| 264 | slot |
| 266 | reset lever |
| 268 | body (of reset lever) |
| 270 | resilient arm (of reset lever) |
| 272 | opening (between body and resilient arm of reset lever) |
| 274 | flange |
| 276 | aperture |
| 278 | elongate slider |
| 280 | Lever (of door locking system) |
| 300 | External module |
| 302 | Sliding block |
| 304 | Locking protrusion |
| 306 | Rocking block |

1. An automatic opening module for a door of a household appliance, comprising:
a housing;
a transmission system, and
a lever engaging pin;
wherein the transmission system and the lever engaging pin are received within the housing;
wherein a first part of the transmission system is operably coupled to the lever engaging pin; and
wherein a second part of the transmission system is configured to operably engage with an actuator of a door locking module such that actuation of the actuator causes the transmission system to move the lever engaging pin between a first, locked, position and a second, unlocked, position.

2. An automatic opening module according to claim 1, wherein, when in the first, locked, position, the lever engaging pin is moved into the housing of the automatic opening module, and when in the second, unlocked position, at least part of the lever engaging pin is moved out of the housing of the automatic opening module.

3. An automatic opening module according to claim 1, wherein the transmission system is a gear assembly, comprising a plurality of gears.

4. An automatic opening module according to claim 3, wherein the first part of the transmission system comprises a first gear of the plurality of gears and the second part of the transmission system comprises a second gear of the plurality of gears.

5. An automatic opening module according to claim 1, wherein the lever engaging pin comprises a rack gear portion that is operably coupled to the first part of the transmission system.

6. An automatic opening module according to claim 1, wherein the first part of the transmission system comprises a clutch mechanism.

7. An automatic opening module according to claim 6, wherein the clutch mechanism comprises a clutch ring comprising at least two resilient tooth members.

8. An automatic opening module according to claim 7, wherein the clutch mechanism comprises a plurality of apertures arranged on an inner surface of the first part of the transmission system.

9. An automatic opening module according to claim 6, comprising a reset lever.

10. An automatic opening module according to claim 9, wherein the reset lever is slidingly engaged with the lever engaging pin.

11. An automatic opening module according to claim 9, wherein the reset lever comprises a body and a resilient arm; and wherein an opening is defined between the body and the resilient arm.

12. An automatic opening module according to claim 11, wherein the housing comprises a protrusion extending from an inner wall of the housing.

13. An automatic opening module according to claim 12, wherein the opening of said reset lever is configured to receive the protrusion of the housing.

14. An automatic opening module according to claim 1, wherein the housing comprises a first opening through which at least a portion of the lever engaging pin extends.

15. An automatic opening module according to claim 14, wherein the housing comprises a second opening through which at least a portion of the second gear extends to operably engage with an actuator of a door locking module.
